(19) United States
(12) Patent Application Publication
(10) Pub. No.: US 2026/0329355 A1
(43) Pub. Date: Oct. 22, 2026

(54) HEAD-MOUNTED COOLING AIR CONDITIONING EQUIPMENT

(71) Applicant: Dongguan Xinghui Technology Co., Ltd., Dongguan (CN)

(72) Inventor: Yongsheng wang, Dongguan (CN)

(73) Assignee: Dongguan Xinghui Technology Co., Ltd, Dongguan (CN)

(21) Appl. No.: 19/402,005

(22) Filed: Nov. 26, 2025

(51) Int. Cl. G06F 1/20

(52) U.S. Cl. CPC G06F 1/203

(57) ABSTRACT

An airflow module designed for use in head-mounted equipment features a housing defining a fan cavity with an integrated centrifugal fan that draws ambient air through an inlet and expels it into a plenum formed between an outer shell and internal partitions. The invention incorporates dual outlet channels separated by internal baffles that direct airflow to distinct exit regions, enabling targeted cooling of separate zones. The housing structure includes features suitable for integration with wearable devices, controlling air distribution while minimizing light leakage and noise. This configuration addresses the technical problem of providing effective ventilation and heat dissipation in compact headgear without compromising user comfort or optical clarity.

### TECHNICAL FIELD

The present invention generally relates to the field of head-mounted apparatus and personal air conditioning systems, and more particularly to techniques for providing cooling airflow in wearable electronic equipment such as virtual reality headsets.

### BACKGROUND

Virtual reality head-mounted displays (HMDs) trace to early stereoscopic and flight-simulator concepts before achieving recognizable HMD form in the 1960s, including Morton Heilig's Telesphere Mask (patented 1960) and Ivan Sutherland's ceiling-suspended “Sword of Damocles,” which demonstrated tracked, computer-rendered wireframe imagery but was impractically heavy for general use. Subsequent decades saw commercial experimentation, such as VPL Research devices in the 1980s and Sega's unreleased Sega VR and Forte VFX1 in the early 1990s, evidencing early head-tracking, stereoscopic displays, and integrated audio but limited by technology maturity. A modern resurgence followed the Oculus Rift prototypes circa 2012 and the introduction of room-scale, sensor-tracked systems exemplified by HTC Vive and SteamVR, catalyzing broad industry participation and sustained product evolution.

Contemporary VR headsets generally comprise a near-eye display assembly providing stereoscopic images through optical elements (lenses) positioned between the displays and the user's eyes to form an immersive field of view with appropriate focal geometry. The head unit typically integrates inertial sensors (e.g., gyroscopes and accelerometers) and, in some designs, optical or external base-station trackers for six-degree-of-freedom pose estimation, coupled with an onboard or tethered compute system to render scenes with low latency and high refresh rates to mitigate motion sickness. Additional subsystems often include integrated or attachable audio transducers, comfort interfaces such as facial gaskets and padding, housing structures and straps for load distribution, and thermal/airflow management features, with materials selected to balance rigidity, weight, breathability, and hygiene.

Despite advances, conventional VR headsets exhibit comfort limitations arising from heat buildup, perspiration accumulation at facial interfaces, and insufficient ventilation within a largely enclosed eye chamber, which can lead to skin irritation, slippage, and general discomfort during extended use or high-exertion applications. A frequent failure mode is lens fogging caused by condensation when warm, humid air near the user's face meets cooler optical surfaces; sweating during active sessions increases local humidity and accelerates fog formation, degrading visibility and immersion. Users and accessory vendors report ad hoc mitigations—such as sweat-absorbent liners, active micro-fans, or anti-fog wipes—but these are often aftermarket, inconsistent, or only partially effective, underscoring a need for integrated, reliable solutions to manage moisture and temperature differentials inside the headset.

### SUMMARY OF THE INVENTION

One aspect of the present invention relates to a head-mounted cooling apparatus for a virtual-reality headset. A head-mounted cooling apparatus may be understood as a device configured to be worn on a user's head and designed to provide thermal management and airflow control. A virtual-reality headset may be understood as a wearable electronic display device that presents immersive three-dimensional visual content to a user and typically includes optical lenses positioned in close proximity to the user's eyes.

The apparatus comprises a main frame configured to be worn at a user's forehead region and having a forward side and an interior side. A main frame may be understood as a structural component that provides mechanical support and mounting surfaces for other components of the apparatus. The forehead region may be understood as the anatomical area of the user's head above the eyebrows and below the hairline. One advantage of this arrangement is that positioning the main frame at the forehead region allows the apparatus to be securely mounted without interfering with the user's field of view or the optical components of the virtual-reality headset. The forward side and interior side of the main frame create distinct mounting zones that enable organized placement of active cooling components on the forward side while maintaining comfortable contact surfaces on the interior side that faces the user's skin. This dual-sided configuration improves ergonomic fit and distributes the weight of the cooling apparatus across the forehead region, reducing pressure points and enhancing user comfort during extended wear periods.

The apparatus includes a mask disposed at a forward region of the apparatus and installed below an eyebrow region of the main frame, the mask including one or more ambient-air inlet openings. A mask may be understood as a panel or cover element that defines apertures or openings for air intake. An eyebrow region may be understood as the portion of the main frame that corresponds anatomically to the area above the user's eyes where eyebrows are located. Ambient-air inlet openings may be understood as apertures that permit external air to enter the apparatus. One advantage of this arrangement is that positioning the mask below the eyebrow region of the main frame ensures that ambient air is drawn from a location forward of and above the optical lenses, where cooler, unheated air is available. The mask with inlet openings provides a controlled entry point for air that prevents ingress of dust, debris, or unintended turbulence while maintaining a defined flow path. The location below the eyebrow region optimizes the intake position to capture air at a sufficient distance from the user's exhaled breath and facial heat, thereby improving the temperature differential available for cooling the lenses and reducing fogging.

The apparatus includes a fan positioned rearward of the mask and supported by the main frame, the fan being operable to draw ambient air through the inlet openings of the mask. A fan may be understood as an electromechanical device comprising rotating blades or impellers that move air by creating a pressure differential. One advantage of this arrangement is that positioning the fan rearward of the mask ensures that the mask functions as a pre-filter and flow conditioner, so that the air entering the fan has already been directed and partially organized by the inlet openings. Supporting the fan on the main frame provides mechanical stability and vibration isolation, preventing transmission of fan-induced vibrations to the virtual-reality headset or the user's head. The fan being operable to draw ambient air through the inlet openings establishes an active forced-air cooling system rather than relying on passive convection, thereby enabling higher volumetric flow rates and greater control over the airflow velocity and direction. This active air movement substantially increases the convective heat transfer coefficient at the lens surfaces, accelerating moisture evaporation and preventing condensation that would otherwise form as fog on the optical lenses.

The apparatus comprises an outer shell mounted to the main frame. An outer shell may be understood as a structural enclosure or housing element that defines exterior surfaces and internal cavities. One advantage of this arrangement is that the outer shell provides a rigid structure that, in cooperation with the main frame, can define and bound internal air passages and plenums. Mounting the outer shell to the main frame creates a modular assembly that can be manufactured, serviced, and replaced independently of the virtual-reality headset itself. The outer shell also serves as a protective barrier that shields internal components such as the fan and air channel structures from external impacts, dust, and moisture. The integration of the outer shell with the main frame establishes a unified structural platform for the cooling apparatus that distributes mechanical loads and maintains alignment of airflow components even during head movements and physical activity.

The apparatus comprises an air channel formed at least in part by the outer shell and aligned with an outlet of the fan, the air channel being configured to receive air from the fan and direct the air downward toward an interior of the virtual-reality headset adjacent optical lenses to mitigate fogging. An air channel may be understood as a duct, passage, or conduit that guides airflow along a defined path. An outlet of the fan may be understood as the discharge side or exit port of the fan where pressurized air exits the fan assembly. Directing the air downward may be understood as orienting the airflow in a gravitationally downward direction toward the optical lenses. Mitigating fogging may be understood as reducing or preventing the condensation of water vapor on lens surfaces. One advantage of this arrangement is that forming the air channel at least in part by the outer shell eliminates the need for separate ducting components, reducing part count and assembly complexity while ensuring precise geometric control of the airflow path. Aligning the air channel with the outlet of the fan minimizes pressure losses and turbulence that would otherwise occur at abrupt transitions or misaligned junctions, thereby preserving the velocity and volumetric flow rate generated by the fan. Configuring the air channel to direct the air downward toward the interior of the virtual-reality headset adjacent the optical lenses ensures that the conditioned airflow is delivered precisely to the region where fogging occurs, which is the interface between the warm, moisture-laden air exhaled by the user and the cooler lens surfaces. The downward airflow creates a continuous flow of drier ambient air across the lens surfaces, displacing humid air and maintaining the lens temperature above the dew point of the surrounding air. This arrangement prevents the formation of condensation droplets that scatter light and degrade optical clarity, thereby mitigating fogging and preserving the user's visual experience during use of the virtual-reality headset.

The apparatus comprises a soft pad coupled along the interior side of the apparatus downstream of the inner shell and arranged to contact the user's forehead during wear. A soft pad may be understood as a cushioning element formed from a compliant, deformable material that provides comfortable contact with skin. One advantage of this arrangement is that coupling the soft pad along the interior side of the apparatus ensures that the user's forehead contacts a comfortable, yielding surface rather than hard structural elements, thereby reducing pressure concentrations and improving wearability during extended use. Positioning the soft pad downstream of the inner shell allows the soft pad to serve as both a comfort interface and a terminal sealing element that prevents bypass airflow from escaping around the edges of the apparatus. The soft pad contacting the user's forehead during wear creates a conformal fit that accommodates variations in individual head shapes and sizes, distributing contact forces over a larger surface area and minimizing discomfort. The compressibility of the soft pad also provides tolerance for manufacturing variations and assembly misalignments, ensuring consistent contact and sealing performance across different users and different virtual-reality headset models.

In another aspect, the air channel has a width greater than half of a width of the virtual-reality headset, thereby distributing airflow across a majority of an optical lens region of the headset. A width of the air channel may be understood as the lateral extent of the air channel measured perpendicular to the direction of airflow. A width of the virtual-reality headset may be understood as the lateral dimension of the headset measured across the user's face from one side to the other. An optical lens region may be understood as the area of the headset where optical lenses are positioned to present visual content to the user's eyes. One advantage of this arrangement is that dimensioning the air channel to have a width greater than half of the headset width ensures that the discharged airflow spans across both optical lenses rather than being concentrated in a narrow central zone. Distributing airflow across a majority of the optical lens region creates uniform convective cooling over substantially the entire surface area where fogging tends to occur, thereby preventing localized condensation zones that would otherwise form at the lateral edges of the lenses where narrower air channels fail to deliver sufficient airflow. The broad airflow distribution also reduces the required air velocity for effective fog mitigation, permitting quieter fan operation while maintaining the lens surfaces above the dew point across their full width.

In another aspect, the air channel comprises internal ribs or baffles configured to guide and condition airflow from the fan, thereby reducing turbulence and acoustic noise while maintaining velocity toward the optical lenses. Internal ribs may be understood as longitudinal protrusions extending from the interior walls of the air channel. Baffles may be understood as plate-like or vane-like structures positioned within the air channel to redirect or organize airflow. Guiding airflow may be understood as directing the flow along a desired path. Conditioning airflow may be understood as altering the flow characteristics to reduce turbulence and improve uniformity. One advantage of this arrangement is that internal ribs or baffles break up large-scale vortices and chaotic flow patterns that would otherwise develop as the high-velocity discharge from the fan enters the air channel, transforming turbulent flow into more laminar, organized flow. Reducing turbulence minimizes pressure losses and acoustic noise generation, which improves both the efficiency of the cooling system and user comfort by decreasing the audible hum or whine produced by the fan and air passages. The ribs or baffles maintain velocity toward the optical lenses by preventing lateral spreading or stagnation of the airflow, ensuring that the momentum imparted by the fan is preserved and delivered to the lens surfaces where it is needed to sweep away moisture-laden air and prevent fogging.

In another aspect, at least a portion of the ribs or baffles is adjustable to vary a direction or intensity of the airflow toward the optical lenses. Adjustable ribs or baffles may be understood as flow-directing elements that can be repositioned or reoriented by the user or by an actuator. Varying a direction of the airflow may be understood as changing the angle or trajectory of the air stream exiting the air channel. Varying an intensity of the airflow may be understood as modulating the local velocity or volumetric flow rate delivered to specific regions of the lens surfaces. One advantage of this arrangement is that adjustability allows the cooling apparatus to be customized for different virtual-reality headset models, different user preferences, and different environmental conditions, such as high-humidity environments where more aggressive airflow is required or low-humidity environments where gentler airflow suffices. The ability to vary direction ensures that the airflow can be aimed precisely at the regions of the lenses most prone to fogging, which may differ depending on the user's breathing pattern, facial anatomy, and the specific geometry of the headset. Varying intensity enables the user to balance cooling performance against acoustic noise and power consumption, providing a tailored user experience that optimizes comfort and optical clarity during extended virtual-reality sessions.

In another aspect, the fan is a brushless direct-current fan selected from the group consisting of an axial-flow fan and a centrifugal-flow fan, and the fan is mounted on the main frame with vibration-damping grommets. A brushless direct-current fan may be understood as an electrically powered fan that uses electronic commutation rather than mechanical brushes, offering improved efficiency and longevity. An axial-flow fan may be understood as a fan in which air flows parallel to the axis of rotation of the impeller. A centrifugal-flow fan may be understood as a fan in which air enters axially and is discharged radially outward due to centrifugal forces. Vibration-damping grommets may be understood as resilient annular elements, typically formed from elastomeric materials, that absorb mechanical vibrations and prevent their transmission to adjacent structures. One advantage of this arrangement is that brushless direct-current fans provide high airflow rates with low power consumption and minimal maintenance requirements, extending battery life in portable virtual-reality systems and reducing heat generation within the fan motor itself. Selecting between axial-flow and centrifugal-flow configurations allows the apparatus to be optimized for different air channel geometries and pressure requirements, with axial fans providing higher volumetric flow rates at lower pressures and centrifugal fans delivering higher pressures suitable for more restrictive air channels. Mounting the fan with vibration-damping grommets isolates the rotational vibrations generated by the spinning impeller from the main frame and the virtual-reality headset, thereby preventing transmission of tactile vibrations to the user's head and reducing structure-borne noise that would otherwise degrade the immersive experience and cause user discomfort during prolonged use.

In another aspect, the apparatus further comprises a liner disposed between an inner shell and the soft pad, the liner being mechanically coupled to the inner shell and providing a structural substrate for positioning the soft pad. A liner may be understood as an intermediate layer or panel positioned between two other components. Mechanically coupled may be understood as physically attached or fastened. A structural substrate may be understood as a load-bearing surface that supports and positions another component. One advantage of this arrangement is that the liner provides a rigid or semi-rigid platform that maintains the shape and position of the soft pad, preventing the soft pad from deforming, bunching, or migrating during use. Disposing the liner between the inner shell and the soft pad allows the liner to function as an interface layer that accommodates dimensional tolerances and assembly variations, simplifying manufacturing and ensuring consistent fit across production batches. The liner being mechanically coupled to the inner shell establishes a stable attachment point that distributes mechanical loads and prevents separation or peeling of the soft pad from the apparatus during repeated donning and doffing cycles. Providing a structural substrate for positioning the soft pad ensures that the soft pad remains properly aligned with the user's forehead, maintaining uniform contact pressure and sealing performance that prevents bypass airflow from escaping around the edges of the apparatus, thereby maximizing the effectiveness of the cooling airflow delivered to the optical lenses.

In another aspect, the soft pad is removably attached to the liner by at least one attachment mechanism selected from the group consisting of snap-fit features, hook-and-loop fasteners, and pressure-sensitive adhesive. Removably attached may be understood as connected in a manner that permits intentional separation without damaging the components. Snap-fit features may be understood as mechanical interlocking elements that engage and disengage through elastic deformation. Hook-and-loop fasteners may be understood as textile fastening systems comprising mating surfaces of hooks and loops. Pressure-sensitive adhesive may be understood as an adhesive that bonds upon application of light pressure without requiring heat or solvent activation. One advantage of this arrangement is that removable attachment enables the soft pad to be detached from the liner for cleaning, replacement, or customization, thereby improving hygiene and extending the useful life of the apparatus. Snap-fit features provide a tool-free, rapid attachment and detachment mechanism that can withstand repeated connection cycles without degradation, facilitating frequent cleaning regimens. Hook-and-loop fasteners offer adjustability and repositionability, allowing users to fine-tune the placement of the soft pad to optimize comfort and sealing for their individual facial contours. Pressure-sensitive adhesive provides a low-profile, lightweight attachment method that does not add bulk or rigid mechanical features that could create pressure points, while still permitting removal by peeling when replacement is needed. The ability to remove and replace the soft pad prevents accumulation of sweat, oils, and contaminants that would otherwise degrade comfort and promote microbial growth, maintaining a sanitary and pleasant user experience over the long-term service life of the cooling apparatus.

In another aspect, the liner includes ventilation features selected from the group consisting of perforations, grooves, microchannels, and raised ribs, the ventilation features being configured to promote airflow between the liner and the soft pad. Ventilation features may be understood as structural elements or apertures designed to facilitate air circulation. Perforations may be understood as small holes or openings that penetrate through the liner. Grooves may be understood as elongated recesses or channels formed in the surface of the liner. Microchannels may be understood as narrow passages having dimensions on the order of micrometers to millimeters. Raised ribs may be understood as linear protrusions that create standoff gaps between adjacent surfaces. One advantage of this arrangement is that ventilation features create air passages between the liner and the soft pad, preventing moisture and heat from being trapped at the interface between these components. Promoting airflow between the liner and the soft pad enhances evaporative cooling of perspiration that accumulates at the user's forehead, reducing discomfort and skin irritation during extended wear periods. Perforations allow transverse airflow to penetrate through the liner and reach the soft pad, while grooves, microchannels, and raised ribs establish lateral flow paths that distribute air across the contact area. The enhanced ventilation reduces the humidity level at the skin-soft pad interface, minimizing the potential for moisture to migrate forward and contribute to fogging of the optical lenses. The improved thermal management at the forehead contact region also reduces the overall heat load within the virtual-reality headset enclosure, further lowering the dew point of the air adjacent to the lenses and thereby enhancing the fog-mitigation effectiveness of the cooling apparatus.

In another aspect, the soft pad comprises a multilayer composite including a backing layer and an outer layer, the outer layer being formed from at least one material selected from the group consisting of medical-grade silicone, thermoplastic elastomer, memory foam, polyurethane foam, and viscoelastic gel. A multilayer composite may be understood as a structure formed from two or more distinct layers of different materials bonded together. A backing layer may be understood as a substrate layer that provides structural support. An outer layer may be understood as the surface layer that contacts the user's skin. Medical-grade silicone may be understood as a biocompatible elastomeric polymer suitable for prolonged skin contact. Thermoplastic elastomer may be understood as a polymer that exhibits rubber-like elasticity but can be processed as a thermoplastic. Memory foam may be understood as a viscoelastic polyurethane foam that conforms to applied pressure and slowly recovers its shape. Polyurethane foam may be understood as a cellular polymer formed by reacting polyols with isocyanates. Viscoelastic gel may be understood as a gel material that exhibits both viscous and elastic properties, deforming under stress and slowly returning to its original shape. One advantage of this arrangement is that the multilayer composite structure allows the backing layer to provide mechanical stability and attachment interfaces while the outer layer provides comfort, conformability, and skin compatibility. Medical-grade silicone offers hypoallergenic properties, ease of cleaning, and durability that resist degradation from sweat and oils. Thermoplastic elastomer provides a soft, compliant surface with good recovery characteristics and economical manufacturing through injection molding or extrusion. Memory foam and polyurethane foam offer excellent pressure distribution by conforming to the unique contours of each user's forehead, minimizing localized pressure concentrations that cause discomfort during prolonged wear. Viscoelastic gel provides superior damping of impact loads and vibrations, enhancing comfort during dynamic head movements typical of virtual-reality gaming and applications. The selection of materials allows the soft pad to be tailored to specific user needs, balancing priorities such as comfort, hygiene, durability, and cost, while ensuring that the soft pad maintains an effective seal against the user's forehead that prevents bypass airflow and maximizes the delivery of conditioned air to the optical lenses for optimal fog mitigation.

### BRIEF DESCRIPTION OF (THE) DRAWINGS

The detailed description is described with reference to the accompanying drawings. In the figures, the left-most digit(s) of a reference number identifies the figure in which the reference number first appears. The use of the same reference numbers in different figures indicates similar or identical components or features.

FIG. 1 is a perspective view illustrating an overall virtual reality (VR) device according to certain embodiments.

FIG. 2 is a rear perspective view of the VR device shown in FIG. 1, taken from an alternate angle to highlight features located at the back of the VR device.

FIG. 3 is a front view illustrating a mask portion and a fan of the VR device, as seen from the front side.

FIG. 4 is an exploded view depicting the main frame and the outer shell of the VR device.

FIG. 5 is a detailed view illustrating an intermediate shell cell with two connecting plates of the VR device.

FIG. 6 is a view depicting a soft pad located at the terminal end of the VR device.

FIG. 7 is an anatomical cross-sectional diagram of the entire VR device, showing all structural layers and components in detail.

### DETAILED DESCRIPTION OF THE EMBODIMENTS

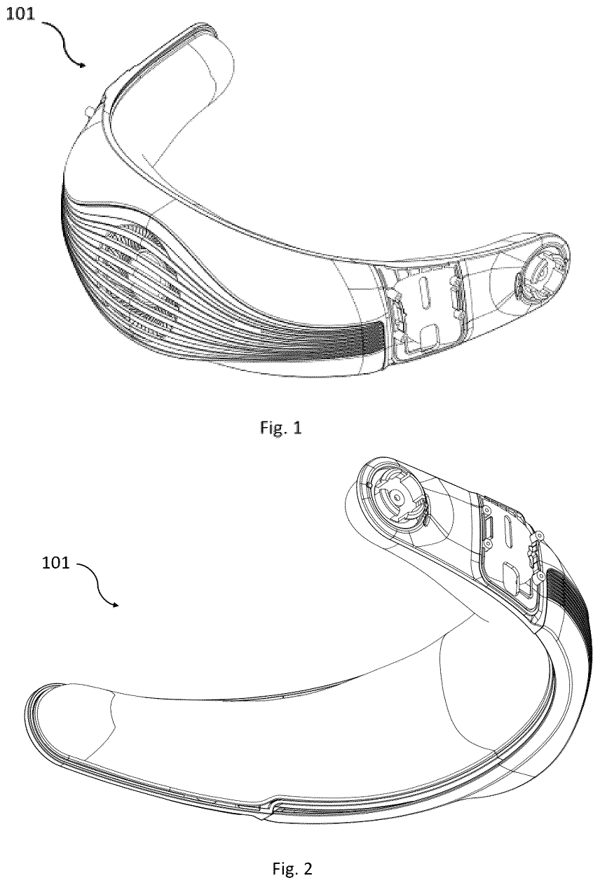

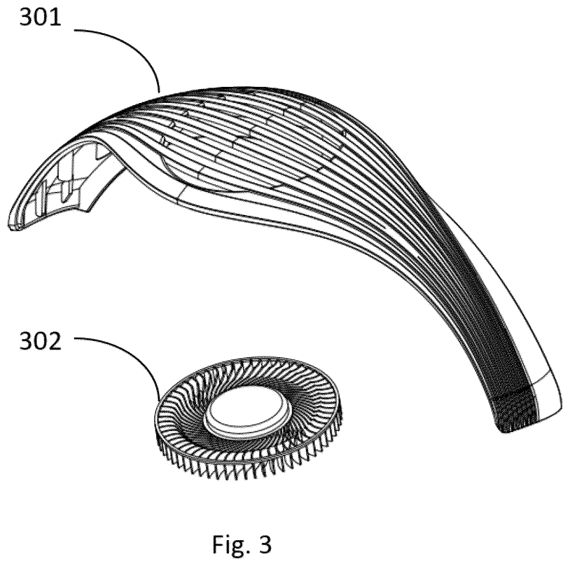

The present invention, the Head-Mounted Cooling Air Conditioning Equipment 101, comprises an integrated wearable system designed to provide active thermal management and ventilation for users wearing extended-duration head-mounted devices, particularly virtual reality headsets, augmented reality systems, and professional industrial equipment. As illustrated in FIG. 1, the Head-Mounted Cooling Air Conditioning Equipment 101 is shown in a front three-quarter perspective view, revealing its streamlined, ergonomically contoured external profile designed to conform to the human head and forehead anatomy. FIG. 2 depicts the equipment from a side profile view, showcasing the curved arc and overall structural silhouette. FIG. 3-8 provides a detailed assembly view showing how the component parts interrelate and integrate during assembly, demonstrating the modular nature of the design and the precise fitting of all elements. FIG. 7 illustrates the assembly relationships and shows several precisely engineered components in exploded view, each shown in detail in the accompanying figures. The equipment is engineered with a narrower profile at both lateral ends, transitioning to a broader central region positioned across the user's forehead, thus optimizing weight distribution and ensuring stable positioning on diverse head shapes and sizes.

The Head-Mounted Cooling Air Conditioning Equipment 101 operates as a semi-autonomous thermal regulation system, employing active forced-air cooling to mitigate heat buildup, reduce lens fogging, and provide continuous user comfort during extended operational periods. The system integrates passive ergonomic comfort features with active electromechanical cooling, creating a unified solution that enhances user experience and device longevity. The overall architecture reflects a modular design philosophy, enabling customization, repair, and component upgrades without requiring replacement of the entire assembly.

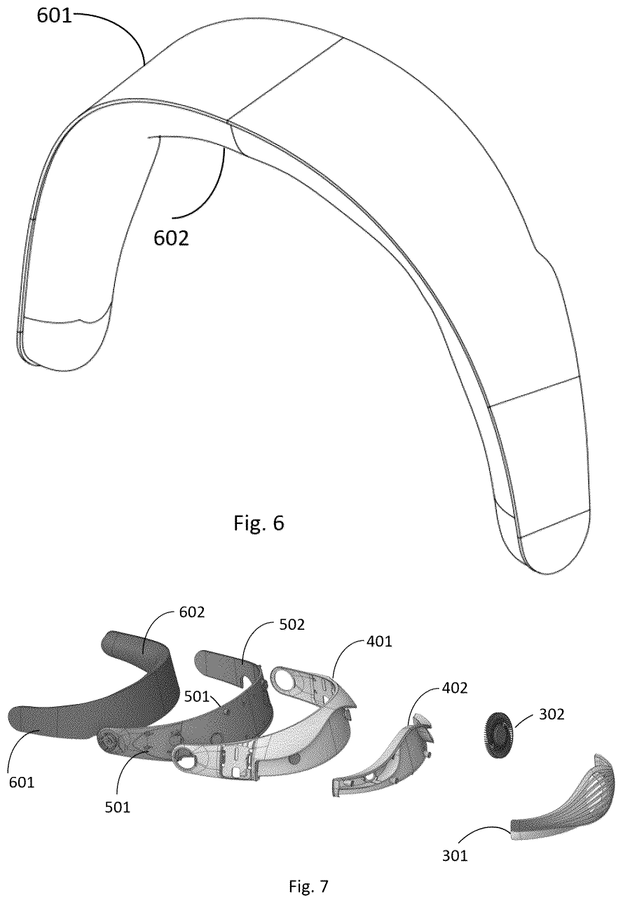

The soft pad 601, as clearly depicted in FIG. 6, is an elongated, curved accessory component positioned along the interior arc of the device, forming the primary tactile interface between the Head-Mounted Cooling Air Conditioning Equipment 101 and the user's skin. The soft pad 601 appears in FIG. 6 as an arched, flexible strip fitting along the inner surface exposed to the user's forehead. Its primary function is to provide comfort, pressure distribution, and skin protection for the wearer, particularly during extended use. The soft pad 601 is shaped to match the natural contour of the human forehead and brow regions. The soft pad 601 is fabricated from a variety of conformable, skin-friendly materials selected to maximize comfort, durability, and hygiene. Primary material options include medical-grade silicone, thermoplastic elastomer, memory foam, polyurethane foam, viscoelastic gel, and other medical-grade silicone elastomers. In premium embodiments, the soft pad 601 may be fabricated from multilayer composite structures, combining a rigid or semi-rigid backing layer with a softer, shock-absorbing outer layer. The external surface may be overlaid with moisture-wicking textile materials such as lycra, microfiber, or mesh to enhance breathability, sweat absorption, and improve user comfort during periods of physical exertion or elevated ambient temperature.

The soft pad 601 functions to cushion and distribute mechanical load evenly across the contact area, reducing localized pressure concentrations that can lead to discomfort or skin irritation during extended wear. By providing a compliant interface, the soft pad 601 ensures that the Head-Mounted Cooling Air Conditioning Equipment 101 remains securely positioned while minimizing user fatigue and allowing for extended, uninterrupted use periods. The material selection for the soft pad 601 is optimized for biocompatibility, thermal comfort, and antimicrobial properties to ensure hygiene and user safety. Alternative embodiments of the soft pad 601 include segmented pad configurations, wherein multiple discrete pad sections are fabricated and positioned at localized high-pressure zones such as the center of the forehead and temple regions, or can be replaced by a set of detachable soft pads positioned at key contact points for individual facial morphologies. This segmented approach allows for localized thickness and stiffness adjustments, optimizing pressure distribution profiles tailored to individual user anatomy. Removable soft pad 601 designs incorporate snap-fit tabs, adhesive backing, or Velcro-compatible surfaces, facilitating rapid removal for cleaning, replacement, or exchange of alternative pad styles suited to different seasons or usage scenarios.

The soft pad 601 is mechanically coupled to the liner 602 through several alternative attachment methods. In the primary embodiment, the soft pad 601 is attached to the liner 602 by means of integrated slots, molded locating bosses, or pressure-sensitive adhesives. This connection secures the soft pad 601 firmly to the liner 602, optimizing comfort and preventing undesirable movement during wear. In alternative designs, the soft pad 601 is attached via discrete snap-fit tabs molded into the rear surface, engaging corresponding slots or recesses in the liner 602. Removable embodiments employ hook-and-loop fasteners, allowing the soft pad 601 to be easily detached for washing, air-drying, or replacement with alternative soft pad 601 variants. The attachment strategy is selected based on end-use requirements, cost considerations, and desired serviceability characteristics.

The liner 602, shown in detail in FIG. 6, is a semi-rigid plastic substrate component positioned immediately beneath the soft pad 601, providing structural support and precise positional alignment within the device housing. The liner 602 is also shown in FIG. 6, positioned beneath the soft pad 601, and serves as a supporting substrate, providing both location and alignment for the soft pad 601 within the device housing. The liner 602 is shaped as an elongated, curved strip that follows the interior arc of the overall equipment. The liner 602 is typically manufactured from semi-rigid plastics such as polypropylene, high-impact ABS, polycarbonate, or flexible acrylic, selected for dimensional stability, lightweight construction, and resistance to moisture and temperature fluctuations.

The liner 602 serves multiple critical functions within the Head-Mounted Cooling Air Conditioning Equipment 101. First, it provides a rigid substrate that maintains the position and geometry of the soft pad 601, preventing unwanted shifting or misalignment during use. Second, it contributes structural rigidity to the internal assembly, distributing mechanical loads from the head interface to the underlying inner shell 501. Third, it provides a clean, easy-to-sanitize surface that can be readily wiped or washed to maintain hygiene standards. The liner 602 may incorporate molded surface features including perforations, ventilation grooves, antimicrobial surface treatments, and moisture-wicking channels to facilitate airflow and hygiene, promoting evaporative cooling and reducing perspiration accumulation.

The liner 602 may be fabricated with integrated ventilation features, including precision-molded perforations arranged in various patterns, microchannel pathways, or raised ribs that create air gaps beneath the soft pad 601. These ventilation features enhance airflow to the user's skin surface, reducing moisture accumulation and improving overall thermal comfort. Alternative embodiments include antimicrobial coatings or agents incorporated into the liner 602 material formulation, inhibiting the growth of bacteria, fungi, or other microorganisms that could compromise hygiene or generate odors during extended use or storage. The liner 602 is mechanically attached to the inner shell 501 through a combination of molded locating bosses, alignment slots, and fastening tabs. In the primary embodiment, the liner 602 is snap-fit or adhesively bonded onto the inner shell 501, utilizing molded alignment guides and retention clips on the liner 602 that correspond to recesses and anchor points within the inner shell 501. This layered connection accurately positions the soft pad 601 along the interior contour of the assembly. In alternative designs, the liner 602 incorporates snap-fit features that allow it to be snapped into place over complementary guide rails or recesses molded into the inner shell 501, enabling rapid assembly and disassembly for maintenance or component replacement. The attachment approach is selected based on production volume, service requirements, and desired product lifecycle characteristics.

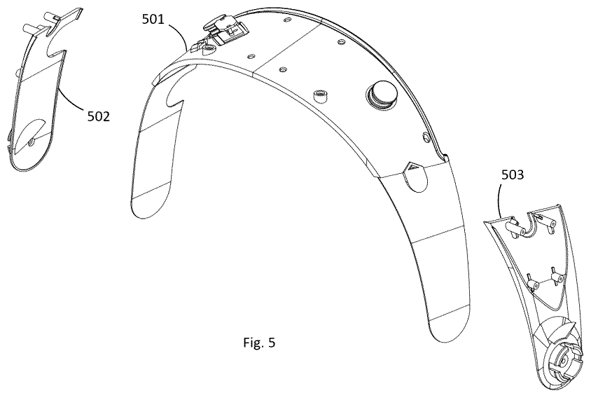

The inner shell 501, comprehensively illustrated in FIG. 5, is a critical component forming the primary aerodynamic plenum and structural scaffold of the Head-Mounted Cooling Air Conditioning Equipment 101. The inner shell 501 is shaped as an elongated, curved cavity with a cross-sectional profile optimized for efficient airflow management and structural load distribution. The inner shell 501 is an aerodynamic and structural element forming the central conduit that channels airflow from the fan 302. It is typically produced from glass-filled nylon, reinforced polycarbonate, polyether ether ketone, or magnesium alloy for advanced variants. The inner shell 501 includes ribbed reinforcements, mounting bosses, and precision alignment slots for the liner 602, soft pad 601, and the centrally mounted fan 302. In other variants, the inner shell 501 may be segmented or include multiple plenum chambers enabling the use of several fans 302 for added airflow control. The inner shell 501 is fabricated from engineering-grade thermoplastics or advanced composite materials, selected for high strength-to-weight ratio, thermal stability, and compatibility with precision injection-molding or compression-molding manufacturing processes. In premium or specialized embodiments, carbon fiber-reinforced polymer or glass fiber-reinforced polypropylene composites may be employed to achieve further weight reduction and enhanced rigidity.

The inner shell 501 contains the central plenum volume through which air from the fan 302 is channeled and distributed toward the outer mask 301. Internal features of the inner shell 501 include precision-molded ribs, baffles, and divider walls that direct and condition airflow to minimize turbulence, pressure loss, and acoustic noise. The inner shell 501 acts as an aerodynamic conduit, smoothing and distributing the forced airflow to minimize pressure losses and noise. Precise internal ribs and baffles within the inner shell 501 guide the air uniformly along the channel, maintaining air velocity and directing the flow toward the outlet region. These aerodynamic features are designed based on computational fluid dynamics analysis and empirical testing to achieve optimal pressure recovery, uniform velocity distribution, and low acoustic signature across the plenum. The inner shell 501 incorporates multiple mounting bosses, threaded inserts, and locating features for securing the liner 602, soft pad 601, fan 302, and connecting plates 502 and 503. These mechanical features are strategically positioned to distribute structural loads and facilitate precise alignment of all connected components. The inner shell 501 may be fabricated as a monolithic single piece or as a segmented assembly comprising upper and lower halves, joined via snap-fit tabs, adhesive bonding, or mechanical fasteners, depending on manufacturing constraints and service requirements.

Alternative embodiments of the inner shell 501 include segmented plenum designs with multiple independent air passages, enabling the integration of multiple fan 302 components in parallel or series configurations for augmented airflow capacity. Dual-plenum designs allow for independent control of cooling zones, delivering targeted airflow to specific regions such as the forehead and temples, or enabling variable airflow intensity settings through software control of individual fan 302 units. Adjustable baffle designs incorporating moveable internal partitions may be employed in some embodiments, permitting real-time optimization of airflow distribution in response to user preferences or environmental conditions. The inner shell 501 is connected to the main frame 401 through a system of mechanical fasteners, snap-fit tabs, and adhesive interfaces distributed along its length and terminal regions. These connections transfer structural loads from the head interface to the main frame 401 and outer shell 402, ensuring overall device rigidity and dimensional stability under normal use conditions.

The left connecting plate 502 and right connecting plate 503, as shown in FIG. 5, are terminal junction components positioned at the respective ends of the inner shell 501. Each connecting plate is shaped to match the terminal cross-sectional profile of the inner shell 501. The left connecting plate 502 and right connecting plate 503 are derived from reinforced polycarbonate, ABS, glass-filled nylon, or lightweight aluminum, serving to anchor and stabilize the ends of the inner shell 501. Each plate features mounting holes, threaded bosses, snap-fit tabs, alignment pins, and, in preferred variants, integrated gaskets or pass-through zones for wires and air channels. For enhanced maintainability, these plates may be detachable, enabling easier access for cleaning or component replacement. The left connecting plate 502 and right connecting plate 503 are fabricated from reinforced thermoplastics including polycarbonate, glass-filled nylon, ABS, or lightweight aluminum alloys, selected for strength, dimensional accuracy, and compatibility with precision manufacturing processes.

The primary function of the left connecting plate 502 and right connecting plate 503 is to provide terminal closure and structural anchoring for the inner shell 501, sealing the plenum cavity at both ends and preventing unwanted air leakage. Each plate incorporates precision-molded mounting holes, threaded bosses, snap-fit tabs, and locating pins that establish rigid mechanical connections with the inner shell 501, main frame 401, and outer shell 402. At each end, the left connecting plate 502 and the right connecting plate 503 are engaged with the terminal edges of the inner shell 501 using tongue-and-groove joints, screw bosses, and snap-lock features that ensure the internal plenum is sealed and stabilized. These connecting plates additionally provide mechanical support for the liner 602, preventing flex or detachment under load. These connecting interfaces ensure coaxial alignment and prevent rotational or translational misalignment during assembly or use. The left connecting plate 502 and right connecting plate 503 may incorporate pass-through apertures or channels for electrical wiring, allowing power and control signals to be routed from internal electronics modules to external power sources or control interfaces. In some embodiments, the connecting plates may integrate sealed connectors, allowing the Head-Mounted Cooling Air Conditioning Equipment 101 to be coupled to external control modules, power supplies, or accessory devices without compromising environmental sealing.

Alternative embodiments of the left connecting plate 502 and right connecting plate 503 include removable or quick-disconnect designs featuring integrated release latches or bayonet-type coupling mechanisms, facilitating rapid assembly and disassembly for maintenance, component replacement, or field servicing. Integrated gasket channels or O-ring grooves may be incorporated to provide environmental sealing, preventing moisture or particulate ingress into the plenum cavity during use in humid or dusty environments. The left connecting plate 502 and right connecting plate 503 are mechanically attached to the inner shell 501 using snap-fit engagement, threaded fasteners, adhesive bonding, or a combination thereof. In the primary embodiment, resilient snap-fit tabs molded into each connecting plate engage corresponding recesses or grooves in the terminal edges of the inner shell 501, creating a secure, tool-free assembly. Alternative designs employ threaded bosses and corresponding threaded holes in the inner shell 501 terminal regions, allowing for rapid, repeatable assembly using standard fasteners. Some embodiments incorporate permanent adhesive bonding, establishing a sealed, lifetime connection suitable for demanding environments or high-reliability applications.

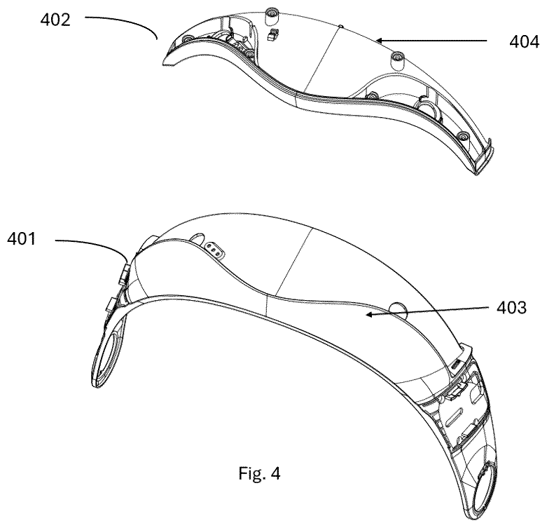

The main frame 401, as depicted in FIGS. 4 and 5, is the central load-bearing structure and chassis of the Head-Mounted Cooling Air Conditioning Equipment 101. The main frame 401 and outer shell 402, as depicted in FIG. 4, form the load-bearing and protective chassis of the assembly. The main frame 401 is shaped as an elongated arch conforming to the contour of the human head. The cross-sectional profile varies along the length, being thicker at the central region and tapering toward the terminal ends to optimize weight distribution and accommodate different head sizes. The main frame 401 provides mounting locations and alignment channels for the inner shell 501, liner 602, soft pad 601, and connecting plates 502 and 503. Manufactured from high-impact polycarbonate, aluminum alloy, or carbon fiber composite, the main frame 401 optimizes rigidity and distributes weight evenly. In preferred embodiments, segmented zones or adjustable features may be included to accommodate different head sizes or integrate modular accessories.

The main frame 401 is fabricated from high-impact thermoplastics including polycarbonate, impact-modified ABS, or engineering resins, or alternatively from lightweight metals including aluminum alloys or magnesium alloys. Material selection is driven by end-use requirements, cost considerations, and desired mechanical properties such as impact resistance, thermal stability, and environmental durability. In premium applications, carbon fiber-reinforced polymer or glass fiber-reinforced epoxy may be employed for enhanced strength and weight reduction. The main frame 401 contains and integrates the inner shell 501, liner 602, soft pad 601, and fan 302, serving as the structural foundation for all mechanical and electromechanical subsystems. Multiple mounting bosses, threaded inserts, conduit channels, and apertures are precision-molded into the main frame 401 to facilitate secure attachment of components and routing of electrical wiring. The internal geometry of the main frame 401 is optimized to support the plenum cavity formed by the inner shell 501 while minimizing overall mass and maintaining adequate ventilation pathways.

The main frame 401 incorporates several alternative design variants to accommodate different applications and user requirements. Adjustable embodiments feature telescopic or segmented structures permitting size adjustment to fit different head sizes across diverse demographic ranges. Segmented main frame 401 designs comprising multiple articulated sections joined by flexible hinges or ball-and-socket joints allow for adaptive contouring to individual head shapes. Modular embodiments feature quick-disconnect interfaces allowing attachment or detachment of auxiliary cooling zones, additional fan modules, or specialized outlets for targeted cooling applications. The main frame 401 is mounted within the main frame 401 via a system of snap-fit tabs, alignment pins, and optional threaded fasteners, which slot into matching holes and grooves in the main frame 401. The main frame 401 is enveloped by the outer shell 402, which is shown both in FIG. 4 and FIG. 7. The outer shell 402 is secured to the main frame 401 through snap-fit latches, alignment tabs, and in some variants, ultrasonic welding or adhesive bonding. This outer shell 402 includes windows and cut-outs for easy mounting of the outer mask 301 and for routing electrical leads to the fan 302. The main frame 401 is affixed to the outer shell 402 through a combination of snap-fit edges, alignment pins, and adhesive or ultrasonic welding, establishing a rigid protective enclosure. This composite structure of main frame 401 and outer shell 402 provides both internal structural integrity and external impact protection, enabling the device to withstand normal use, handling, and storage conditions without degradation or performance loss.

In an additional embodiment, the head-mounted cooling air conditioning equipment 101 further comprises an eyebrow structure 403, which is mounted on the main frame 401, and wherein a mask 301 is installed below the eyebrow 403. The eyebrow 403 is configured to direct airflow in a controlled downward manner, assisting in channeling air from the fan 302 through air channel 404 into the interior of the VR device 101. Specifically, the eyebrow 403 prevents inadvertent upward or scattered airflow, thus ensuring that the air is directed more smoothly downward along and through air channel 404, effectively enhancing airflow uniformity and increasing the overall strength of air intake through the fan 302. The coordinated arrangement of eyebrow 403, mask 301, and air channel 404 delivers improved anti-fogging performance and more comfortable ventilation over extended use periods.

The outer shell 402, comprehensively shown in FIG. 4, forms the external protective casing and visible exterior of the Head-Mounted Cooling Air Conditioning Equipment 101. The outer shell 402 can be seen fitting over the main frame 401, featuring snap-fit tabs, alignment bosses, windows, and protective overhangs. The outer shell 402 exhibits a smooth, continuously curved external profile designed for both visual aesthetics and ergonomic integration with the user's head. The outer shell 402 is manufactured as a single-piece molded component or, alternatively, as separable upper and lower sections joined along a centerline or lateral seam.

The outer shell 402 is fabricated from durable, cosmetically finished thermoplastics including polycarbonate, PC-ABS blends, thermoplastic urethane, or specialty engineering resins. Material selection prioritizes impact resistance, scratch and UV resistance, dimensional stability across temperature ranges, and aesthetic finish quality. Materials for the outer shell 402 may range from polycarbonate and PC-ABS blends to cast magnesium or acrylic in specialty versions, providing impact resistance, protection, and an aerodynamic external contour. In specialty applications, cast magnesium alloys, anodized aluminum, or aramid fiber-reinforced polymers may be employed for enhanced durability or specialized performance characteristics. The outer surface may incorporate textured, matte, or glossy finishes, color customization, or decorative elements to suit manufacturer branding or user preferences.

The outer shell 402 serves multiple critical functions: (1) it provides impact protection for internal components, guarding against mechanical damage from drops, collisions, or environmental contact; (2) it provides structural rigidity, contributing to overall device stiffness and dimensional stability; (3) it seals and protects internal electronics and airflow pathways from environmental contamination, moisture, and particulates; and (4) it provides the primary aesthetic interface with the user and external observers, enabling customization and brand differentiation. The outer shell 402 incorporates apertures, windows, or recesses for integration with the outer mask 301, allowing partition strips and air outlet features to protrude or remain flush with the external surface. Perforated regions or venting apertures may be strategically positioned to complement airflow distribution from the outer mask 301, enhancing cooling effectiveness while maintaining light sealing at the optics interface. Removable shell sections or modular panels may be incorporated in some embodiments, facilitating access to internal components for maintenance, cleaning, or component replacement. Integrated ventilation apertures and removable shell sections can be used for enhanced airflow and easier maintenance.

The outer shell 402 is attached to the main frame 401 using snap-fit engagement along the perimeter, with complementary locking tabs and receptacles providing secure assembly. Alternative attachment methods include adhesive bonding, ultrasonic or heat welding, or mechanical fastening via hidden screws and bosses. The connection strategy is selected to balance production efficiency, desired product lifetime, and serviceability requirements. Alternative embodiments of the outer shell 402 include ventilated designs with perforations or louvers that enhance external airflow and cooling, transparent or translucent materials permitting visibility of internal components or status indicators, and modular shell systems with interchangeable outer covers supporting customizable aesthetics and functional variations.

The fan 302, prominently featured in FIG. 3, is the primary electromechanical component driving active airflow throughout the Head-Mounted Cooling Air Conditioning Equipment 101 system. The fan 302, positioned centrally as displayed in FIG. 3, serves as the air-moving mechanism. This can be a brushless centrifugal, axial, or mixed-flow fan constructed from polybutylene terephthalate, glass-filled nylon, aluminum, magnesium alloy, or high-speed resin. The fan 302 is a compact, high-efficiency centrifugal or axial-flow impeller mounted centrally within the plenum cavity formed by the inner shell 501. Its function is to draw ambient air into the device housing and channel it efficiently through the plenum formed by the inner shell 501, directing it toward the outlet zones in the outer mask 301. The fan 302 is constructed from high-performance materials including polybutylene terephthalate or nylon for the impeller blade assembly, selected for strength, fatigue resistance, and dimensional stability at elevated rotational speeds. The impeller comprises multiple asymmetric or backward-curved blades precisely engineered to generate centrifugal force and propel air radially outward into the surrounding plenum. Motor components, including stator coils and permanent magnets, are typically encapsulated in epoxy or potted with silicone resin to provide environmental protection and electrical insulation. The motor is a brushless DC type, selected for low acoustic signature, high efficiency, long operational lifetime, and compatibility with electronic speed control modules.

The fan 302 generates active suction at its inlet, drawing ambient air through the intake slots and perforations of the outer mask 301, while simultaneously generating pressure that propels this air through the inner shell 501 plenum and directs it toward the exhaust outlets. Upon activation, the fan 302 generates suction at the inlet, drawing air in from the outer mask 301 and propelling it through its impeller system. Depending on the embodiment, a single fan 302 or multiple parallel fans 302 may be employed to vary airflow output and cooling zones. The noise signature of the fan 302 is optimized through impeller blade geometry, motor balance, and vibration isolation techniques to ensure user comfort during extended wear. The fan 302 is mounted within the plenum cavity via precision-molded mounting bosses or retaining clips that secure the motor housing to the inner shell 501 and main frame 401. The fan 302 is fitted into a dedicated mounting cavity within the inner shell 501 and main frame 401. It is retained either by snap-on rings, threaded screw mounts, or support brackets with anti-vibration grommets to dampen operational noise. Vibration-damping grommets, typically fabricated from silicone or elastomer materials, are interposed between the fan 302 mounting points and the structural frames, attenuating vibrational transmission and reducing acoustic noise propagation to the user's head and ears.

Electrical connections to the fan 302 comprise low-voltage wires routed through conduit channels in the main frame 401 to a control module or external power supply. Electrical connectors are slotted through integrated channels in both the main frame 401 and outer shell 402, connecting the fan 302 to its power supply and controls without impeding the device's structural integrity. An integrated thermal fuse or overheat protection circuit may be incorporated into the fan 302 motor assembly, providing automatic shutdown in the event of excessive temperature rise, preventing damage or safety hazards. Alternative embodiments of the fan 302 include dual-fan configurations with multiple separate fan 302 units positioned in offset plenum chambers, enabling augmented airflow capacity or independent zone-specific cooling control. Multiple fan 302 units may be used in parallel or tandem arrangements for increased airflow throughput or zone-specific cooling, as required in alternate device configurations. Multi-speed fan 302 designs allow variable airflow intensity via software control, user preferences, or automated thermal sensing, permitting optimization for different activity levels, ambient conditions, or personal comfort settings. Some embodiments incorporate variable-pitch impeller blades or adjustable inlet vanes, permitting real-time airflow and pressure modulation independent of motor speed, enabling precise thermal management algorithms.

Replacement and serviceability of the fan 302 are supported through quick-disconnect electrical connectors and mechanical mounting interfaces, allowing technicians to remove and replace the fan 302 module without disassembling the entire device. Modular fan 302 cartridges with integrated mounting brackets facilitate rapid field replacement, minimizing device downtime and supporting long-term operational availability.

The outer mask 301, as clearly depicted in FIG. 3, is the frontmost component forming the aerodynamic intake interface and the air exhaust distribution structure. The outer mask 301 is designed not only as an aesthetic and structural element but also as the primary intake face for exterior ambient air. The airflow path begins at the air inlet formed in the outer mask 301. The mask incorporates precisely dimensioned inlet slots and perforations that allow outside air to be efficiently directed into the internal plenum. When the device is operating, ambient air enters through these dedicated inlets in the outer mask 301. The outer mask 301, as exhibited in FIG. 3, acts as the final air distribution and outlet component mounted at the front of the device. The outer mask 301 is shaped as an elongated, curved blade with a streamlined profile designed to minimize aerodynamic drag and optimize visual aesthetics when integrated into the overall Head-Mounted Cooling Air Conditioning Equipment 101 assembly.

The outer mask 301 is constructed from injection-molded ABS, PC-ABS, reinforced nylon, transparent polycarbonate, or composite polymers with acoustic and optical properties tailored for the application. The outer mask 301 is fabricated from injection-molded thermoplastics including acrylonitrile butadiene styrene, PC-ABS blends, reinforced nylon, transparent polycarbonate, or specialty engineering resins. Material selection balances durability, aesthetic finish quality, light transmission properties, and compatibility with precision molding of fine airflow features. In specialty applications requiring enhanced acoustic damping or thermal properties, materials with embedded sound-absorbing fillers or thermal-conductive particles may be employed.

It features a series of horizontal partitions and curved strips supported by a base plate, which control airflow direction and velocity. The central partitions are thicker at the top and bottom, while terminal sections converge into flattened, triangular shapes for focused air exhaust. Beneath the wider partitions, pre-drilled slots are configured for secure installation of the fan 302. Carefully scaled perforations and slits regulate air passage, while integrated light seals and acoustic dampers improve comfort and minimize noise leakage. The outer mask 301 incorporates an array of horizontal partition strips supported by underlying base plates, creating a ribbed external surface. These partitions serve dual functions: (1) they provide structural rigidity and load distribution, and (2) they channel and direct airflow at exit, optimizing pressure recovery and creating defined cooling zones. Air inlet apertures in the outer mask 301 are strategically positioned at the front face, comprising discrete slots or perforated regions that allow ambient air to be drawn into the system when the fan 302 is activated. These inlet features are sized and positioned to minimize air velocity concentrations and reduce inlet noise. The inlet geometry is contoured to transition smoothly from the external ambient environment to the internal plenum, minimizing separation losses and turbulence.

Air outlet apertures or vent zones are located at the lower edge and sides of the outer mask 301, creating a distributed exhaust that sweeps cool air across the user's forehead, brow, and facial regions. The outlet region is strategically located at the underside of the device, as formed by the lower partitions and vent openings in the outer mask 301. At this point, the directed airflow is discharged from the bottom edge of the device, expelling cooled air downward along the user's facial surface and the VR headset interface. This exhaust zone is engineered with partition strips and slots, optimizing the spread and velocity of the outgoing air for maximum cooling and fog mitigation. The outlet geometry comprises slots, perforations, or narrow passages designed to achieve optimal exit velocities for thermal comfort. Multiple exit zones enable targeted cooling delivery to different facial regions, mitigating hot spots and ensuring uniform thermal comfort. The outer mask 301 may incorporate integrated light-sealing features including soft elastomeric flanges or gasket surfaces that contact the user's face, minimizing light leakage into the optical path of VR or other head-mounted optical devices. These sealing surfaces are fabricated from soft silicone or TPU materials for skin compatibility and repeated-use durability.

Alternative embodiments of the outer mask 301 include modular designs with interchangeable partition sets, allowing the same basic housing to be configured with different airflow characteristics suited to specific applications or user preferences. Adjustable louvered designs with moveable partition elements permit real-time control of outlet flow direction and velocity distribution. Transparent or semi-transparent outer mask 301 variants allow visibility of internal airflow features and may support integrated optical functions or aesthetic customization. Dual-outlet designs with independent upper and lower exhaust zones enable selective cooling of different facial regions, supporting zone-specific thermal management strategies. The outer mask 301 is mounted at the forward region of the assembly, interlocking with the main frame 401 and outer shell 402 by a coordinated series of snap-fit tabs, dovetail joints, and in some versions, threaded fasteners. The pre-drilled slots and partition perforations in the outer mask 301 align with the outlets of the fan 302, ensuring efficient air transfer and distribution. When alternative fan configurations are employed, such as multiple parallel fans, the inner shell 501 and outer mask 301 include additional chambers and mounting points to enable modular installation. The outer mask 301 is attached to the main frame 401 and outer shell 402 using snap-fit tabs, adhesive bonding, or threaded fasteners positioned along its perimeter. Quick-disconnect features facilitate removal for cleaning or replacement with alternative outer mask 301 configurations.

In an additional embodiment, the Head-Mounted Cooling Air Conditioning Equipment 101 further comprises an air channel 404 configured to receive air from the fan 302 and direct airflow downward toward the interior of the VR device 101. The air channel 404 is positioned such that its width is greater than half of the width of the VR device 101, ensuring broad and effective distribution of airflow across the device's internal region. The air channel 404 is formed between the main frame (401) and the outer shell 402, and is aligned with the outlet of the fan 302 to facilitate efficient transfer of air from the fan 302 into the air channel 404.

The primary function of the air channel 404 is to channel the airflow generated by the fan 302 into the interior of the VR device 101, specifically targeting the region adjacent to the optical lenses. By directing a stream of air across the lens surfaces, the air channel 404 actively mitigates the formation of condensation and fogging on the lenses, thereby maintaining clear visibility and enhancing the user experience during extended use. The width of the air channel 404 is specifically designed to exceed half of the width of the VR device 101, ensuring that the airflow is distributed broadly and uniformly across the lens area, rather than being confined to a narrow region. This design feature maximizes the effectiveness of the anti-fogging mechanism, as the airflow is able to reach and clear moisture from a larger surface area of the lenses.

The air channel 404 may be further optimized with internal ribs or baffles to guide and condition the airflow, minimizing turbulence and ensuring a smooth, laminar flow across the lens surfaces. In some embodiments, the air channel 404 may include adjustable features, such as movable baffles or louvers, to allow for real-time optimization of airflow distribution based on user preferences or environmental conditions. The air channel 404 is mechanically coupled to the main frame (401) and outer shell 402 through a combination of snap-fit tabs, alignment pins, and adhesive interfaces, ensuring a secure and stable connection that maintains the integrity of the airflow path during normal use conditions.

This embodiment provides a robust solution for preventing lens fogging in VR devices, leveraging the broad width of the air channel 404 to deliver effective and uniform airflow across the lens surfaces. The integration of the air channel 404 with the existing cooling system enhances the overall thermal management and user comfort of the VR device 101, supporting extended use in a variety of environments and applications.

The airflow path created by the combined action of the air inlet, fan 302, inner shell 501, and bottom outlet is continuous and unobstructed, delivering comfort directly to the user while keeping the device ventilated and reducing heat buildup. Every part supports and enhances this airflow path: the outer mask 301 shapes and collects incoming air, the fan 302 provides active air movement and pressure, the inner shell 501 controls distribution, and the outlet regions at the device base ensure efficient delivery of cooled and refreshed air to the user. In alternative configurations, additional fans 302 or supplementary ductwork within the inner shell 501 may be utilized to create variable airflow paths and cooling intensities adapted for individual user preferences and device environments. The harmony of these components and their integrated airflow system produces a VR glasses air conditioning device capable of maintaining a comfortable, thermally regulated user experience.

Once air enters the device through the outer mask 301, it is immediately channelled toward the fan 302, shown in FIG. 3, which is positioned centrally within the housing cavity formed by the inner shell 501 and main frame 401. The fan 302 serves as the active driving force for airflow. After passing through the fan 302, the accelerated air enters the curved plenum formed by the inner shell 501, as visible in FIG. 5. The inner shell 501 acts as an aerodynamic conduit, smoothing and distributing the forced airflow to minimize pressure losses and noise. Precise internal ribs and baffles within the inner shell 501 guide the air uniformly along the channel, maintaining air velocity and directing the flow toward the outlet region.

Each component of the Head-Mounted Cooling Air Conditioning Equipment 101 is coupled together using thoughtfully designed mechanical interfaces to ensure robustness, easy assembly, and precise alignment. Through this network of fitments—snap-locks, ribbed guides, adhesive zones, threaded bosses, and molded mating interfaces—the individual components form a unified air conditioning device optimized for reliable performance, modular upgradability, and user-friendly assembly, with every connection point engineered for security, longevity, and ease of maintenance.

In assembly, each component is brought together as depicted in FIG. 7. The liner 602 is affixed to the inner shell 501, followed by the attachment of the soft pad 601 to the liner 602. The inner shell 501 is then integrated into the main frame 401, with the ends anchored by connecting plates 502 and 503 to seal the plenum and stabilize the structure. The fan 302 is installed in its allocated cavity within the inner shell 501 and main frame 401, with electrical wiring routed through internal conduits. The outer shell 402 is then locked onto the main frame 401, establishing an external shield and reinforcing the assembly. Lastly, the outer mask 301 is snap-fitted to the front section, engaging all anchor and airflow control features for final function. In alternative configurations, auxiliary or replacement fans 302 can be mounted in additional chambers within the inner shell 501 and outer mask 301, allowing customizable airflow schemes for specific VR requirements. This arrangement brings together advanced ergonomic materials, a modular mechanical structure, and a flexible assembly method, delivering optimal comfort and precise ventilation for VR users while supporting easy adaptation, maintenance, and customization.

The operational principle of the Head-Mounted Cooling Air Conditioning Equipment 101 centers on active thermal regulation through controlled airflow generation and distribution. When activated via external power supply and control interface, the fan 302 commences rotation at a controlled speed, generating aerodynamic suction and pressure within the plenum cavity formed by the inner shell 501. The airflow path initiates at the air inlet perforations or slots in the outer mask 301, where atmospheric air is drawn inward by the negative pressure generated upstream of the fan 302 impeller. This ambient air passes through the intake geometry of the outer mask 301, transitioning from external ambient to the internal inlet of the fan 302. The intake design minimizes flow separation and turbulence, optimizing inlet efficiency and reducing acoustic noise.

As the fan 302 impeller rotates, its blades accelerate the inflowing air radially outward, increasing both velocity and pressure. The accelerated air is discharged into the surrounding plenum cavity formed by the inner shell 501, where internal baffles and aerodynamic features direct and condition the flow. The plenum acts as an expansion chamber, decelerating the air flow and recovering pressure energy through smooth, gradual geometry transitions. This pressure recovery reduces exit velocity noise and improves overall system efficiency. The conditioned airflow is directed through internal ducting within the inner shell 501 toward the exhaust outlets formed by partition gaps and perforations in the outer mask 301. As air passes through these outlet apertures, it accelerates to optimal exit velocities, creating a consistent, cooling airstream. The distributed nature of the exhaust outlets ensures that cool air is delivered across multiple zones of the user's forehead and facial region, providing broad thermal coverage and maximizing comfort.

The overall airflow path can be summarized as: (1) ambient air ingress through outer mask 301 intake slots, (2) air acceleration and pressurization by fan 302, (3) pressure recovery and flow conditioning within inner shell 501 plenum, (4) distribution through internal ducting, and (5) exhaust discharge through outer mask 301 exit apertures directly into contact with the user's face and VR headset interface. Control of airflow intensity is achieved through adjustment of fan 302 motor speed via electronic speed control methods, typically implemented via microcontroller-based control modules. Airflow can be varied continuously from minimum to maximum rated capacity, permitting user preference adjustment or automatic thermal management based on internal temperature sensors or external environmental conditions.

In a primary use case, a user engages in an extended immersive VR gaming session utilizing a high-performance VR headset. The user places the Head-Mounted Cooling Air Conditioning Equipment 101 on their forehead, securing it via the soft pad 601 and main frame 401 contact surfaces. The equipment is powered via a portable battery pack or direct connection to the VR system power supply, with the fan 302 operating at a mid-to-high speed setting to generate substantial airflow. As the user engages in intense gaming with rapid head movements and visual processing, their metabolic rate increases and heat accumulates around the forehead and eye regions. The continuous airflow from the Head-Mounted Cooling Air Conditioning Equipment 101 disperses this accumulated heat, reduces skin surface temperature, and minimizes lens fogging on the VR optical displays. The soft pad 601 provides comfortable contact pressure distribution, preventing discomfort or pressure-related headaches that might otherwise develop during extended wear. User comfort is significantly enhanced, enabling longer gaming sessions without heat-related fatigue or optical degradation.

In a second scenario, industrial workers undergo virtual reality training for equipment operation or hazardous scenario response in a manufacturing facility with elevated ambient temperatures. Multiple workers wear Head-Mounted Cooling Air Conditioning Equipment 101 units while using industrial-grade VR training systems. Each equipment unit operates at full fan 302 speed to counteract both metabolic heat from concentration and physical activity and elevated ambient temperature. The modular nature of the Head-Mounted Cooling Air Conditioning Equipment 101 allows multiple trainees to utilize identical hardware with customizable comfort settings. Quick-release soft pad 601 designs permit rapid cleaning and sanitation between trainees, maintaining hygiene standards required in industrial environments. The robust construction of the main frame 401 and outer shell 402 withstands the rigorous handling and occasional impacts typical of factory training environments. The equipment's thermal management capability enables extended training sessions without interruption, improving training efficiency and knowledge retention.

In a third scenario, surgical teams employ Head-Mounted Cooling Air Conditioning Equipment 101 integrated with surgical AR visualization systems to provide enhanced intraoperative guidance during complex procedures. Surgeons wear the equipment continuously throughout multi-hour surgical procedures, with the fan 302 operating at moderate speed to maintain thermal comfort while minimizing acoustic distraction in the sterile surgical environment. The equipment's soft pad 601 provides ergonomic comfort during prolonged standing and precise manual work, while the active cooling prevents the cognitive fatigue and reduced dexterity that can accompany heat stress during extended surgical procedures. The precision cooling also prevents fogging of integrated optical displays or AR visualization optics, maintaining visualization quality critical for surgical safety and accuracy. The modular construction permits rapid sterilization or replacement of soft pad 601 and liner 602 components to maintain sterility protocols, while the robust structural design withstands repeated sterilization cycles and medical-grade disinfection processes.

The Head-Mounted Cooling Air Conditioning Equipment 101 supports numerous design variations and configuration alternatives to accommodate diverse applications, user demographics, and performance requirements. These alternatives encompass variations in component materials, fan 302 configurations, control strategies, and integration with external systems. An alternative embodiment incorporates multiple independent fan 302 units positioned in separate plenum chambers within the inner shell 501, enabling augmented airflow capacity and independent control of upper and lower cooling zones. This configuration provides enhanced thermal management for demanding applications and permits selective zone cooling based on real-time user preference or thermal sensing. Alternative main frame 401 and outer shell 402 designs feature segmented or telescopic construction, enabling size adjustment across a wider range of head sizes and anatomies, accommodating users typically excluded from one-size-fits-all designs.

Advanced embodiments incorporate embedded microcontroller-based control modules that adjust fan 302 speed automatically based on internal temperature sensors, user input commands, or programmed algorithms, optimizing cooling output while minimizing power consumption and acoustic noise. Specialized embodiments emphasize rapid removal, cleaning, and replacement of soft pad 601 and liner 602 components, with design features facilitating sanitation or disinfection of soft components, suitable for medical, hospitality, or shared-use environments. Embodiments designed for specialized VR or AR applications may integrate transparent outer mask 301 or outer shell 402 components, enabling direct visualization of internal cooling features or integration with optical combiner elements and display technology.

The Head-Mounted Cooling Air Conditioning Equipment 101, as comprehensively described throughout this detailed embodiment section and illustrated across FIGS. 1-7, represents a sophisticated, modular solution for active thermal management in wearable head-mounted applications. The integration of precision aerodynamic design, biocompatible comfort materials, robust mechanical structures, and efficient electromechanical cooling enables extended user comfort and optimal performance in diverse operational contexts ranging from consumer VR entertainment to professional medical and industrial applications. The modular architecture, alternative configuration options, and design flexibility ensure broad applicability across diverse user requirements and market segments, supporting customization, maintainability, and long-term operational value for manufacturers, service providers, and end users alike.

1. A head-mounted cooling apparatus for a virtual-reality headset, comprising:
a main frame configured to be worn at a user's forehead region and having a forward side and an interior side;
a mask disposed at a forward region of the apparatus and installed below an eyebrow region of the main frame, the mask including one or more ambient-air inlet openings;
a fan positioned rearward of the mask and supported by the main frame, the fan being operable to draw ambient air through the inlet openings of the mask;
an outer shell mounted to the main frame;
an air channel formed at least in part by the outer shell and aligned with an outlet of the fan, the air channel being configured to receive air from the fan and direct the air downward toward an interior of the virtual-reality headset adjacent optical lenses to mitigate fogging;
a soft pad coupled along the interior side of the apparatus downstream of the inner shell and arranged to contact the user's forehead during wear.

2. The head-mounted cooling apparatus of claim 1, wherein the air channel has a width greater than half of a width of the virtual-reality headset, thereby distributing airflow across a majority of an optical lens region of the headset.

3. The head-mounted cooling apparatus of claim 1, wherein the air channel comprises internal ribs or baffles configured to guide and condition airflow from the fan, thereby reducing turbulence and acoustic noise while maintaining velocity toward the optical lenses.

4. The head-mounted cooling apparatus of claim 3, wherein at least a portion of the ribs or baffles is adjustable to vary a direction or intensity of the airflow toward the optical lenses.

5. The head-mounted cooling apparatus of claim 1, wherein the fan is a brushless direct-current fan selected from the group consisting of an axial-flow fan and a centrifugal-flow fan, and wherein the fan is mounted on the main frame with vibration-damping grommets.

6. The head-mounted cooling apparatus of claim 1, further comprising a liner disposed between an inner shell and the soft pad, the liner being mechanically coupled to the inner shell and providing a structural substrate for positioning the soft pad.

7. The head-mounted cooling apparatus of claim 6, wherein the soft pad is removably attached to the liner by at least one attachment mechanism selected from the group consisting of snap-fit features, hook-and-loop fasteners, and pressure-sensitive adhesive.

8. The head-mounted cooling apparatus of claim 6, wherein the liner includes ventilation features selected from the group consisting of perforations, grooves, microchannels, and raised ribs, the ventilation features being configured to promote airflow between the liner and the soft pad.

9. The head-mounted cooling apparatus of claim 1, wherein the soft pad comprises a multilayer composite including a backing layer and an outer layer, the outer layer being formed from at least one material selected from the group consisting of medical-grade silicone, thermoplastic elastomer, memory foam, polyurethane foam, and viscoelastic gel.
